(19) United States
(12) Patent Application Publication
(10) Pub. No.: US 2014/0099905 A1
(43) Pub. Date: Apr. 10, 2014

(54) MOBILE DEVICE-INTEGRATED MULTIBAND TWO-WAY RADIO AND RADIO OVER INTERNET PROTOCOL GATEWAY DEVICE

(71) Applicant: Robert Jimenez, Elmwood Park, NJ (US)

(72) Inventor: Robert Jimenez, Elmwood Park, NJ (US)

(21) Appl. No.: 14/050,775

(22) Filed: Oct. 10, 2013

Related U.S. Application Data
(60) Provisional application No. 61/711,795, filed on Oct. 10, 2012.

(51) Int. Cl. H04W 4/10; H04B 1/38

(52) U.S. Cl. CPC H04W 4/10; H04B 1/3833
USPC 455/90.2

(57) ABSTRACT

The present invention relates generally to a radio device. More specifically, the present invention is a multiband two-way radio and Radio over Internet Protocol (RoIP) device onto which a mobile device may be docked. Embodiments of the present invention incorporate the features of two-way radio and RoIP into the mobile device platform. Embodiments of the present invention are also capable of functioning as a standalone device independent of a mobile device. Embodiments of the device serve as a protective case for the mobile device and also features a secondary battery for the mobile device or for the device during independent use.

### CROSS-REFERENCE TO RELATED APPLICATIONS

This application is a continuation of U.S. Provisional Patent Application No. 61/711,795 filed on Oct. 10, 2012 and entitled “Mobile device-Integrated Multiband Two-Way Radio and Radio over Internet Protocol Gateway Device” the entire disclosure of which is incorporated herein by reference.

### FIELD OF THE INVENTION

The present invention relates generally to a radio device. More specifically, the present invention is a multiband two-way radio and Radio over Internet Protocol (RoIP) device onto which a mobile device may be docked. Embodiments of the present invention incorporate the features of two-way radio and RoIP into the mobile device platform. Embodiments of the present invention are also capable of functioning as a standalone device independent of a mobile device. Embodiments of the device serve as a protective case for the mobile device and also features a secondary battery for the mobile device or for the device during independent use.

### BACKGROUND OF THE INVENTION

Two-way radios are a convenient means of instant communication. They are often available in the form of handheld transceivers, commonly known as “walkie-talkies”. Communication via two-way radio requires an external electronic device such as the aforementioned walkie-talkies. Voice signals transmitted by multiple two-way radio devices are often routed through an external Radio over Internet Protocol (RoIP) gateway device to other two-way radio devices. RoIP gateways are capable of interconnecting a large number of two-way radio devices and transmitting voice signals to the devices.

One problem is that these gateway devices are generally not portable or conveniently portable. Requiring hardware and a power source (generally current drawn from a wall socket), the RoIP gateways are limiting in that they act as a central point for the handheld radios or walkie-talkies.

Another disadvantage of the non-portable RoIP gateway is that it becomes a limiting factor for the portability of the handheld radios, which must stay in range of the RoIP in order to receive and transmit the communications information. Since the broadcast range of the handheld devices may be limited, the users are effectively tethered to the RoIP gateway in terms of how far they can travel away from the RoIP gateway before losing communication with the ROIP gateway.

Given the ubiquitous nature of Internet connected devices in the world, providing access to the internet for use as a RoIP gateway should not require tethering or a dedicated fixed position power source. The average smartphone or other mobile computing device (i.e., mobile device) carries enough processing power and data transmission and receipt capabilities to act as a RoIP gateway. However, the average mobile device lacks the ability to detect, receive and process data provided over multiband voice based radio frequency transmissions.

Therefore, there is need in the art for systems and methods for providing a multiband two-way radio and Radio over Internet Protocol (RoIP) device onto which a mobile device may be docked. These and other features and advantages of the present invention will be explained and will become obvious to one skilled in the art through the summary of the invention that follows.

### SUMMARY OF THE INVENTION

Accordingly, it is an aspect of the present invention to provide a multiband two-way radio and Radio over Internet Protocol (RoIP) device onto which a mobile device may be docked. Embodiments of the present invention incorporate the features of two-way radio and RoIP into the mobile device platform. Embodiments of the present invention are also capable of functioning as a standalone device independent of a mobile device. Embodiments of the device may also serve as a protective case for a mobile device and may also features a secondary battery for the mobile device or for the device during independent use.

An object of certain embodiments of the present invention is to provide a means of integrating the functions of a multiband two-way radio device and a RoIP gateway device with a mobile device. Embodiments of the present invention provide for a multiband two-way radio device and RoIP gateway device that may be physically docked to a mobile device. Preferred embodiments of the present invention encase the entire mobile device while allowing full functionality of the mobile device. The mobile device utilizes a software program or application to manage the frequency and channel of the radio device when docked. The present invention may also be used as a standalone two-way radio and gateway device independent of a mobile device. In its preferred embodiment, the present invention comprises a top housing piece, bottom housing piece, and antenna that are connected together and docked to a mobile device. In addition to functioning as a two-way radio and gateway device, the present invention also serves as a protective casing for the mobile device and includes a secondary battery to supplement the mobile device battery.

The present invention allows communication with two-way radio devices using common frequencies such as Ultra High Frequency (UHF), Very High Frequency (VHF), 800 MHz, and 700 MHz frequencies. The present invention functions as a RoIP gateway through the Internet or mobile broadband networks. This allows the device to serve as a hub for interconnecting multiple two-way radio devices and for transmitting voice signals to the connected devices.

According to an embodiment of the present invention, a multiband two-way radio over internet protocol gateway device includes: a housing, comprising: a top housing piece constructed from a durable material and comprising a plurality of control means configured to allow a user to adjust a radio volume and adjust a radio channel; a bottom housing piece comprising a durable material and configured to connect with said top housing piece to encase a mobile device; an antenna port configured to receive an antenna designed to improve reception of radio signals; and a push-to-talk control means configured to allow a user to engage a voice transmission over the radio channel selected by one or more of the plurality of control means.

According to an embodiment of the present invention, the device further includes one or more data ports configured to allow access to control elements of said mobile device when said housing encases said mobile device.

According to an embodiment of the present invention, the data ports are selected from the group comprising USB ports, HDMI ports, touch screen ports, power source ports, switch ports, button ports, audio jack ports and data connection ports.

According to an embodiment of the present invention, the housing further includes a battery configured to provide power to said device.

According to an embodiment of the present invention, the battery is integrated into said bottom housing piece.

According to an embodiment of the present invention, the battery is contained in a compartment integrated into said bottom housing piece.

According to an embodiment of the present invention, the control means are selected from the group comprising dials, buttons, switches, levers and capacitive touch screens.

According to an embodiment of the present invention, the housing is configured to utilize software and hardware elements on said mobile device for providing radio over internet protocol services.

According to an embodiment of the present invention, the antenna is received into said antenna port via a mating screw attachment means.

According to an embodiment of the present invention, the antenna port is attached to said bottom housing piece.

According to an embodiment of the present invention, the antenna port is attached to said top housing piece.

According to an embodiment of the present invention, the device is configured to provide radio over internet protocol services without being engaged with said mobile device.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 is an isometric view of an embodiment of the top housing piece, in accordance with an embodiment of the present invention;

FIG. 2 is an isometric view of an embodiment of the bottom housing piece, in accordance with an embodiment of the present invention;

FIG. 3 is an isometric view of an example mobile device to be docked to a housing, in accordance with an embodiment of the present invention;

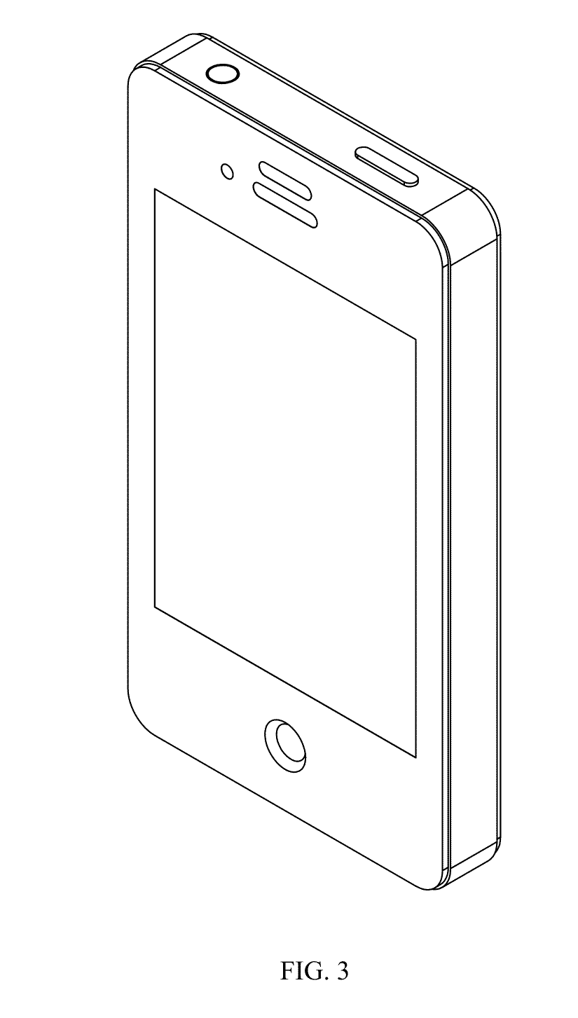

FIG. 4 is an isometric view of an embodiment of the assembled present invention as a standalone device without mobile device;

FIG. 5 is an isometric view of an embodiment of the assembled present invention with docked mobile device;

FIG. 6 is a back view of an embodiment of the assembled present invention;

FIG. 7 is a side view of an embodiment of the assembled present invention;

FIG. 8 is an exploded isometric view of the present invention detailing how the top housing piece, bottom housing piece, and antenna are assembled and docked to a mobile device;

FIG. 8 is a schematic view of a network connected to a multiband two-way RoIP device, in accordance with an embodiment of the present invention; and

FIG. 10 is a schematic of an exemplary mobile device that may be used in conjunction with embodiments of the present invention.

All illustrations of the drawings are for the purpose of describing selected versions of the present invention and are not intended to limit the scope of the present invention.

### DETAIL DESCRIPTIONS OF THE INVENTION

The present invention is a multiband two-way radio and Radio over Internet Protocol (RoIP) gateway device that is physically docked to a mobile device. In its preferred embodiment, the present invention comprises a mobile device housing, comprising a top housing piece, a bottom housing piece, and an antenna. The housing pieces and the antenna are physically connected to a mobile device in order to allow the mobile device to serve as a multiband two way radio and RoIP gateway device. Additionally, the present invention may be used as a standalone device to provide the aforementioned functions independent of a mobile device. The present invention also functions as a protective case for the mobile device and contains a secondary battery for supplemental power to the mobile device or for independent use of the standalone device.

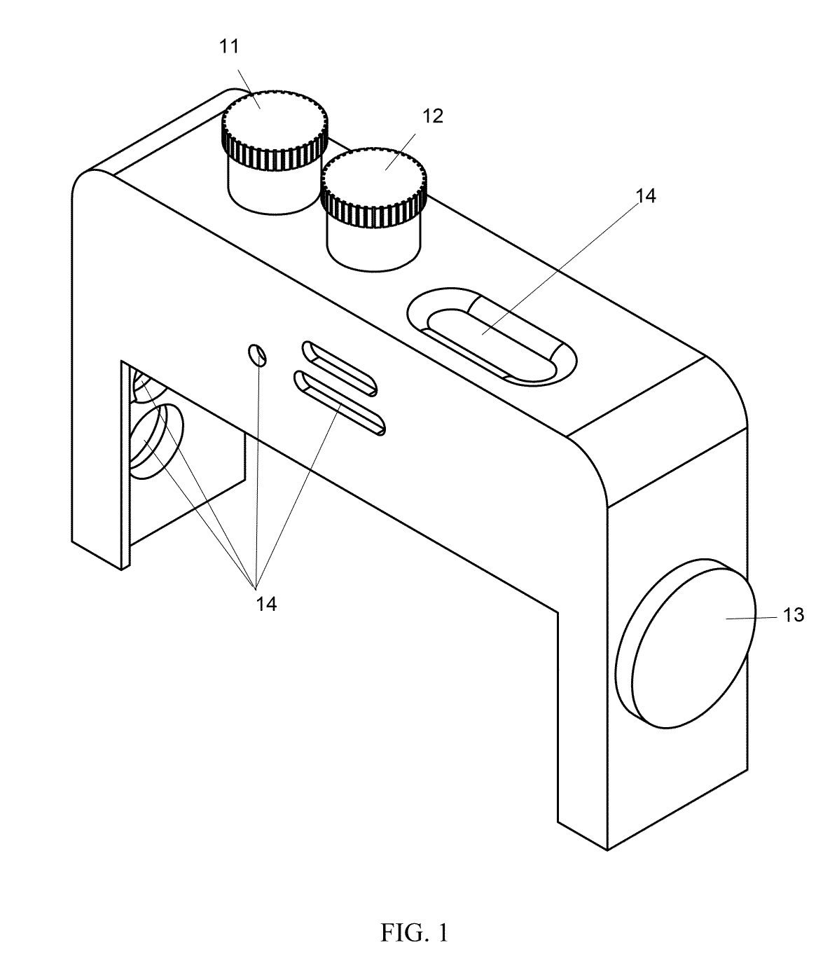

In the preferred embodiment of the present invention, a top housing piece comprises a piece of durable material. The durable material is shaped to conform to the upper portion of a mobile device as shown in FIG. 1. The durable material of the top housing piece is durable to protect any mobile devices the housing is covering. Example durable materials include, but are not limited to, silicone and rubber. One of ordinary skill in the art would appreciate that there are numerous types of durable materials that could be utilized with embodiments of the present invention, and embodiments of the present invention are contemplated for use with any durable material.

In the preferred embodiment of the present invention, the top housing piece further comprises two adjustable dials. The first dial 11 may be turned to adjust radio channels and the second dial 12 may be turned to adjust volume of the device. In other embodiments, the two adjustable dials could be replaced by other forms of control means, including, but not limited to, dials, levers, switches, capacitive touchscreen devices, buttons or any combination thereof. The control means can be configured to adjust the aforementioned adjustable properties of the invention (e.g., volume, radio channel). One of ordinary skill in the art would appreciate that there are numerous types of control means that could be utilized with embodiments of the present invention and embodiments of the present invention are contemplated for use with any type of control means.

According to an embodiment of the present invention, the top housing piece further comprises a push-to-talk (PTT) button located on the exterior of the top housing piece in an easily accessible position. In other embodiments, the PTT button may be located in other locations on the invention, including, but not limited to, any other location on the housing (e.g., top housing piece, bottom housing piece). In yet another embodiment, the PTT button may be replaced or substituted for any other PTT control means, including, but not limited to, a capacitive touch screen device, a switch, a lever or any combination thereof. One of ordinary skill in the art would appreciate that there are numerous types of PTT control means that could be utilized with embodiments of the present invention, and embodiments of the present invention are contemplated for use with any type of PTT control means.

Certain embodiments of the present invention may feature a microphone and/or speaker on the top housing piece. This allows the present invention to be used as a standalone device independent of a mobile device, or otherwise provide audio capabilities for a mobile device that does not include integrated audio components.

According to an embodiment of the present invention, the top housing piece 10 may further comprise a plurality of ports and openings 14 for any input and output features of a mobile device. In the preferred embodiment of the present invention, these ports and openings 14 are for features including, but not limited to, on/off switches, speaker ports, camera ports, data ports (e.g., USB ports, HDMI ports), power ports (e.g., AC adapter), volume adjustment buttons of the mobile device, and audio output jacks. The ports and openings 14 corresponding to features of mobile devices allow the mobile devices to be used normally when the present invention has been attached to the mobile devices. Certain models of mobile devices may require the top housing piece to be physically connected to the mobile devices. As such, certain embodiments of the present invention may feature a docking port on the top housing piece for connecting to a mobile device.

In the preferred embodiment of the present invention, a bottom housing piece 20 comprises a piece of the same durable material as that of the top housing piece. In other embodiments, the durable material of the top housing piece and the bottom housing piece may be different. The bottom housing piece also serves as a durable protective cover for a mobile device.

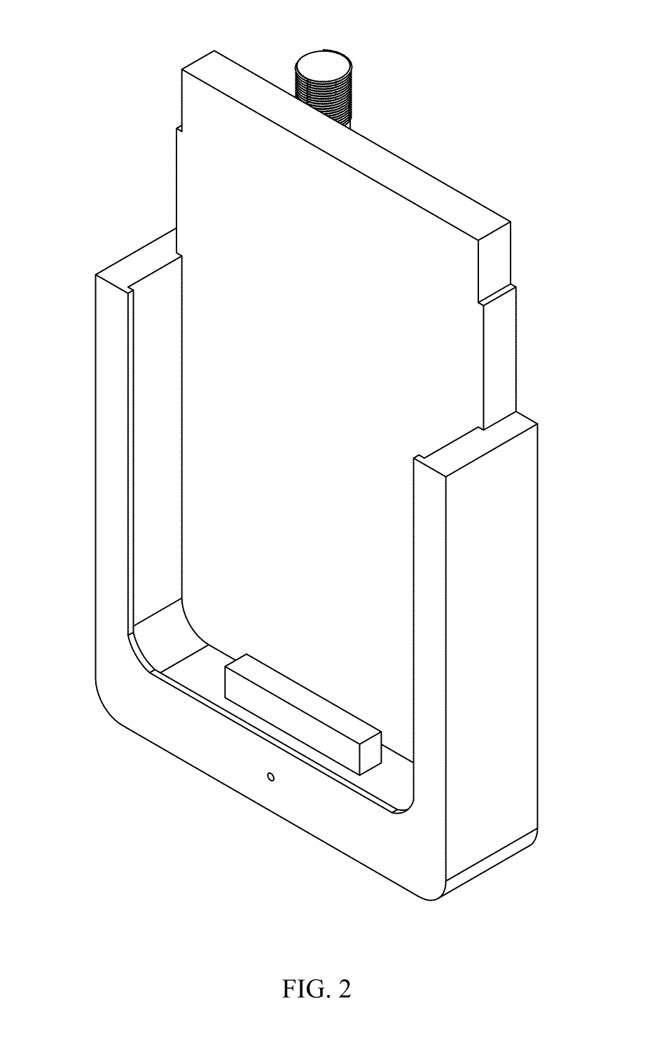

As with the top housing piece, the bottom housing piece is shaped to conform to the bottom portion of a mobile device as shown in FIG. 2. In the preferred embodiment of the present invention, the bottom housing piece further comprises an antenna port 21. The antenna port 21 allows a standalone antenna 22 to be attached to the bottom housing piece of the present invention. In other embodiments, the antenna port may be attached to the top housing piece.

The method of attachment between the antenna 22 and the antenna port 21 is via threaded screwing although alternative attachment methods may be utilized. One of ordinary skill in the art would appreciate that there are numerous attachment means that could be utilized for attaching the antenna to the antenna port, and embodiments of the present invention are contemplated for use with any such attachment means.

In the preferred embodiment of the present invention, the bottom housing piece further comprises a lithium ion battery contained in a battery compartment 61. The secondary battery (i.e., the lithium ion battery contained in the battery compartment 61) supplements the battery of a mobile device on which the present invention is docked. Additionally, the battery allows the present invention to be used as a standalone device independent of a mobile device. The battery is protected by a removable protective covering and is rechargeable. The present invention may be connected to an external power source for extended use as well as for recharging the secondary battery.

As with the top housing piece, the bottom housing piece also further comprises a plurality of ports and openings for corresponding input and output features of a mobile device. Similarly, certain embodiments of the present invention may feature a microphone and/or speaker on the bottom housing piece to allow the present invention to be used as a standalone device independent of a mobile device. Finally, the bottom housing piece may feature a docking port to accommodate mobile device models that require the bottom housing piece to be physically docked to the mobile devices.

In the preferred embodiment of the present invention, an antenna comprises a cylindrical extrusion with a first end and second end. The first or second end features threading that allows the antenna to be screwed onto the antenna port of the bottom housing piece. The antenna is adjustable when attached to the antenna port. The antenna is detachable for easy storage of the present invention and to minimize the space taken up by the present invention.

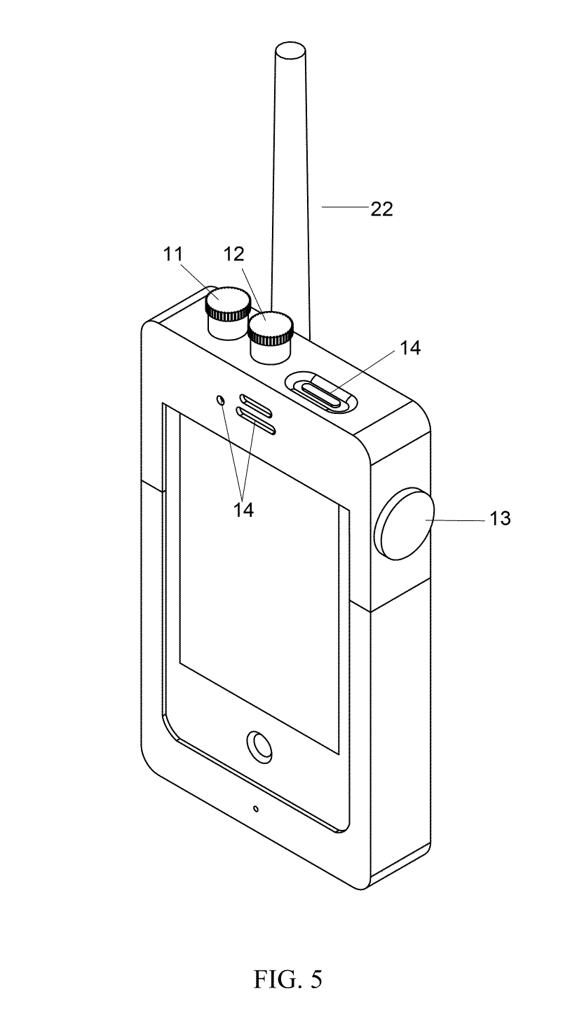

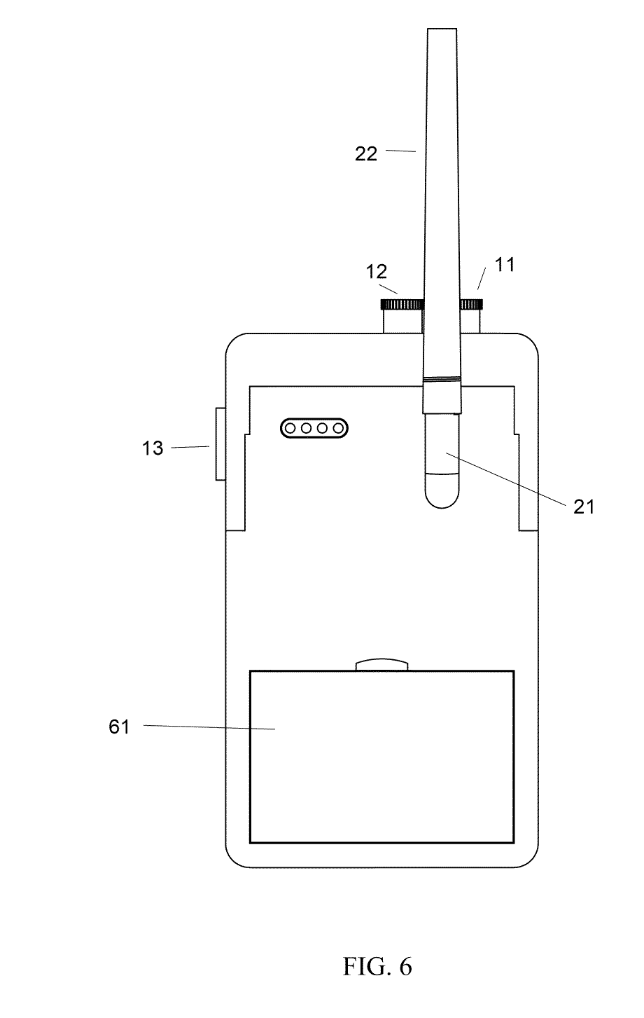

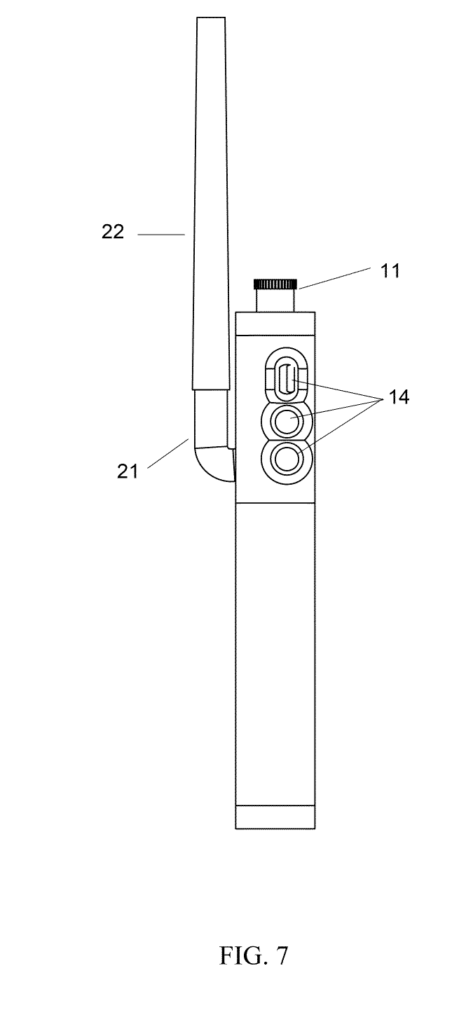

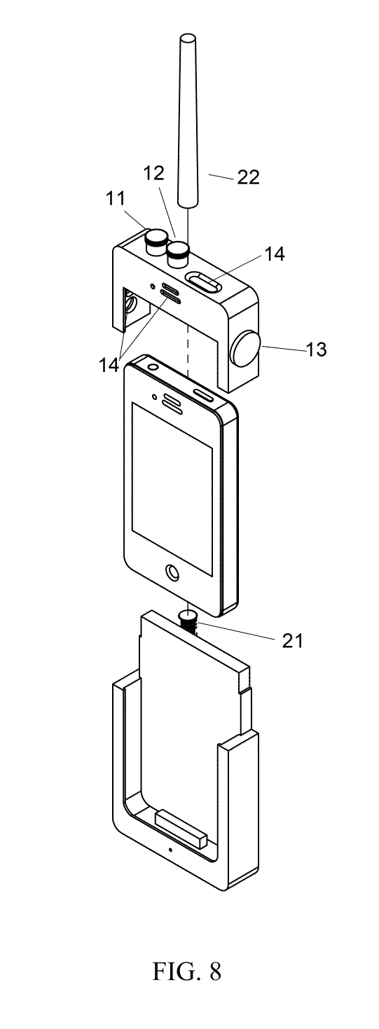

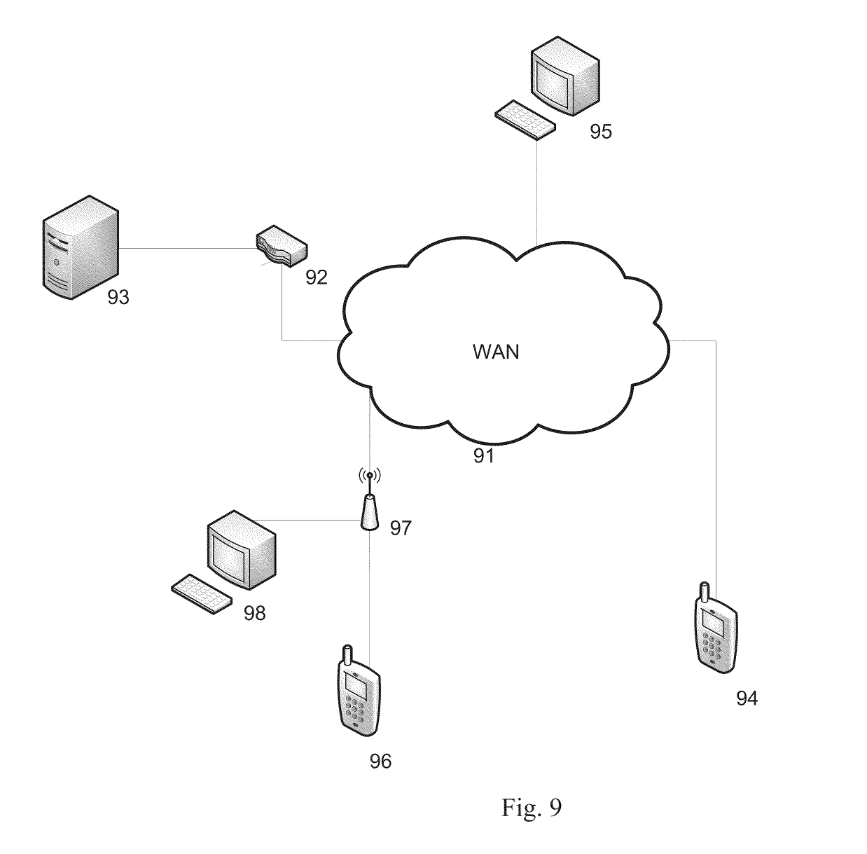

The present invention is physically docked to a mobile device. In the preferred embodiment of the present invention, the top housing piece and second housing piece engage and lock together to completely cover a mobile device as shown in FIG. 5-8. The mobile device screen is left uncovered as well as any input and output features of the mobile device. The antenna is screwed onto the antenna port of the bottom housing piece. In the example embodiment shown in FIG. 8, the bottom housing piece physically connects to the mobile device's docking port. However, alternative embodiments of the present invention may feature alternative locations for docking ports. When physically docked to a mobile device, the present invention serves as a durable protective casing for the mobile device. It is important to note that the mobile device's functionality is not limited in any way when docked to the present invention.

The present invention allows a mobile device to be utilized as a multiband two-way radio. Once docked to a mobile device, the present invention is used to communicate with external two-way radio devices. The present invention is compatible with a wide range of frequencies including, but not limited to, Ultra High Frequency (UHF), Very High Frequency (VHF), 800 MHz, and 700 MHz frequencies. This allows the present invention to communicate with two-way radios in applications such as public safety, construction, and military communications.

As previously noted, in preferred embodiments of the present invention, frequency and volume are controlled via the two adjustable dials featured on the top housing piece if the present invention is being utilized independent of a mobile device. If docked to a mobile device, frequency and volume may be adjusted via the mobile device. In order to allow this, a software program or application is used to manage the frequency and channel of the two-way radio. The PTT button of the top housing piece is pressed to allow a user to transmit. The present invention also allows a mobile device to be utilized as a RoIP gateway device. RoIP is utilized if a mobile device is connected to the Internet or a mobile broadband network. The present invention is capable of interconnecting communications devices and serves as a hub for routing multiband two-way radio voice signals to the connected communications devices.

According to an embodiment of the present invention, a mobile device may communicate with the present invention via one or more wireless means (e.g., Bluetooth, WI-FI, near field communication (NFC)). In these embodiments, the mobile device does not necessarily need to be docked with the invention in order to communicate and provide interactivity between the mobile device and the invention. Data may be communicated from a communications means of the invention to the mobile device over one of the designated wireless communication means. Further, where multiple two-way radio devices are being used, the mobile device can act as a RoIP gateway device for a plurality of those two-way radio devices. This is advantageous in that it allows a single portable mobile device to function as a central (but still mobile) point of communication between the two-way radio devices and the RoIP gateway services utilized in conjunction with the two-way radio devices.

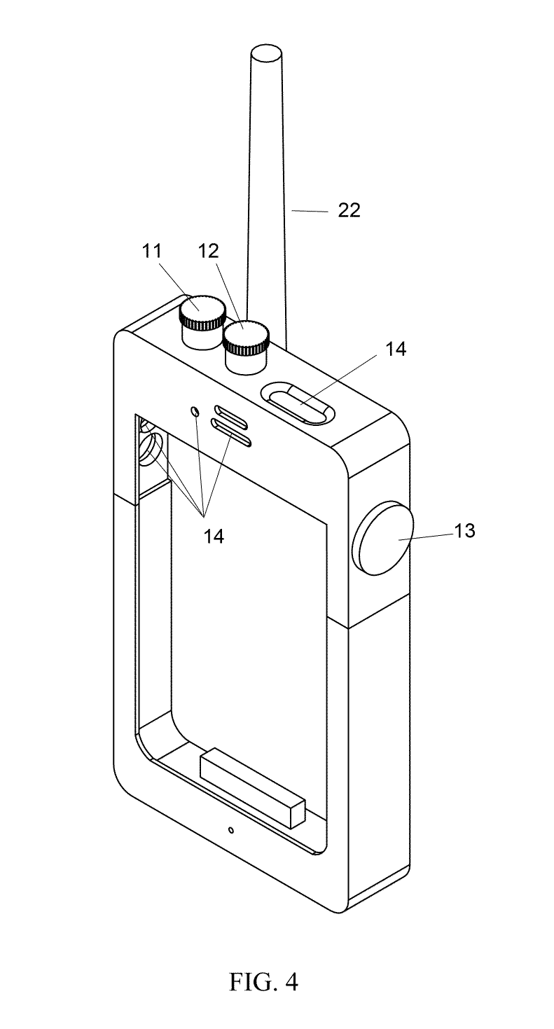

The present invention may be used as a standalone multiband two-way radio and RoIP gateway device when not connected to a mobile device. This configuration is shown in FIG. 4.

In the preferred embodiment of the present invention, the antenna dock is featured on the bottom housing piece of the present invention. Alternative embodiments of the present invention may feature the antenna dock located in different locations such as on the top housing piece.

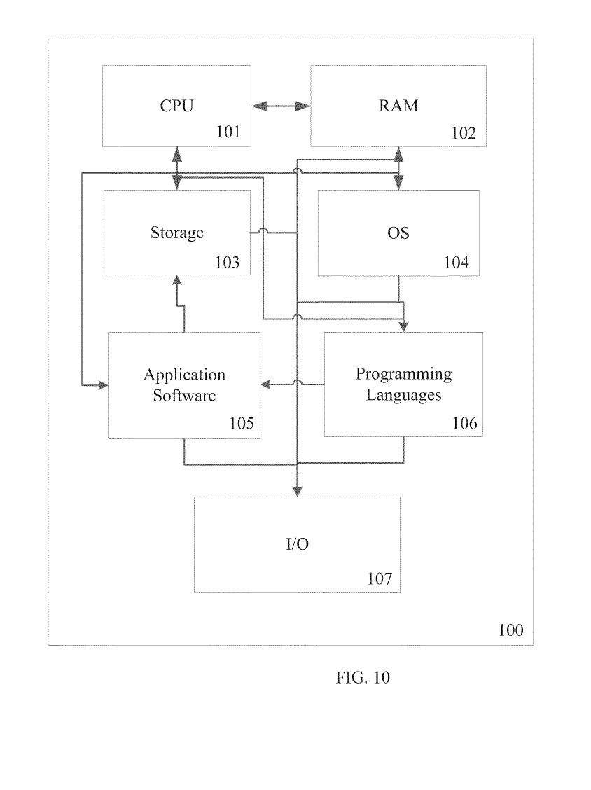

According to an embodiment of the present invention, the mobile devices the invention is used with may be selected from any number of mobile computing devices. As shown in FIG. 10, One of ordinary skill in the art would appreciate that a mobile computing device 100 appropriate for use with embodiments of the present application may generally be comprised of one or more of a Central processing Unit (CPU) 101, Random Access Memory (RAM) 102, a storage medium (e.g., hard disk drive, solid state drive, flash memory, cloud storage) 103, an operating system (OS) 104, one or more application software 105, one or more programming languages 106 and one or more input/output devices/means 107. Examples of computing devices usable with embodiments of the present invention include, but are not limited to, personal computers, smartphones, laptops, mobile computing devices, tablet PCs and servers.

In an exemplary embodiment according to the present invention, data may be provided to the invention across local area networks (LANs) (e.g., office networks, home networks) or wide area networks (WANs) (e.g., the Internet). In accordance with the previous embodiment, the invention may be provided information from servers or other computing devices communicatively connected across one or more LANs and/or WANs. One of ordinary skill in the art would appreciate that there are numerous manners in which the system could be configured and embodiments of the present invention are contemplated for use with any configuration.

Referring to FIG. 9, a schematic overview of a system for communicating RoIP data, in accordance with an embodiment of the present invention, is shown. The system is comprised of one or more application servers 93 for electronically storing information used by the system. Applications in the application server 93 may retrieve and manipulate information in storage devices and exchange information through a Network 91 (e.g., the Internet, a LAN, WiFi, Bluetooth, etc.). Applications in server 93 may also be used to manipulate information stored remotely and process and analyze data stored remotely across a Network 91 (e.g., the Internet, a LAN, WiFi, Bluetooth, etc.).

According to an exemplary embodiment, as shown in FIG. 2, exchange of information through the Network 91 may occur through one or more high speed connections. In some cases, high speed connections may be over-the-air (OTA), passed through networked systems, directly connected to one or more Networks 91 or directed through one or more routers 202. Router(s) 92 are completely optional and other embodiments in accordance with the present invention may or may not utilize one or more routers 92. One of ordinary skill in the art would appreciate that there are numerous ways server 93 may connect to Network 91 for the exchange of information, and embodiments of the present invention are contemplated for use with any method for connecting to networks for the purpose of exchanging information. Further, while this application refers to high speed connections, embodiments of the present invention may be utilized with connections of any speed.

Components of the system may connect to server 93 via Network 91 or other network in numerous ways. For instance, a component may connect to the system i) through a computing device 95 directly connected to the Network 91, ii) through a computing device 96, 98 connected to the WAN 91 through a routing device 97, or iii) through a computing device 94 via a wireless connection (e.g., CDMA, GMS, 3G, 4G) to the Network 91. One of ordinary skill in the art would appreciate that there are numerous ways that a component may connect to server 93 via Network 91, and embodiments of the present invention are contemplated for use with any method for connecting to server 93 via Network 91. Furthermore, server 93 could be comprised of a personal computing device, such as a smartphone, acting as a host for other computing devices to connect to.

Throughout this disclosure and elsewhere, block diagrams and flowchart illustrations depict methods, apparatuses (i.e., systems, mobile device RoIP gateway), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A multiband two-way radio over internet protocol gateway device, the device comprising:
a housing, comprising:
a top housing piece constructed from a durable material and comprising a plurality of control means configured to allow a user to adjust a radio volume and adjust a radio channel;
a bottom housing piece comprising a durable material and configured to connect with said top housing piece to encase a mobile device;
an antenna port configured to receive an antenna designed to improve reception of radio signals; and
a push-to-talk control means configured to allow a user to engage a voice transmission over the radio channel selected by one or more of the plurality of control means.

2. The device of claim 1, further comprising one or more data ports configured to allow access to control elements of said mobile device when said housing encases said mobile device.

3. The device of claim 2, wherein said one or more data ports are selected from the group comprising USB ports, HDMI ports, touch screen ports, power source ports, switch ports, button ports, audio jack ports and data connection ports.

4. The device of claim 1, wherein said housing further comprises a battery configured to provide power to said device.

5. The device of claim 4, wherein the battery is integrated into said bottom housing piece.

6. The device of claim 4, wherein the battery is contained in a compartment integrated into said bottom housing piece.

7. The device of claim 1, wherein said control means are selected from the group comprising dials, buttons, switches, levers and capacitive touch screens.

8. The device of claim 1, wherein said housing is configured to utilize software and hardware elements on said mobile device for providing radio over internet protocol services.

9. The device of claim 1, wherein said antenna is received into said antenna port via a mating screw attachment means.

10. The device of claim 1, wherein said antenna port is attached to said bottom housing piece.

11. The device of claim 1, wherein said antenna port is attached to said top housing piece.

12. The device of claim 1, wherein the device is configured to provide radio over internet protocol services without being engaged with said mobile device.
